(19) United States
(12) Patent Application Publication
(10) Pub. No.: US 2016/0055886 A1
(43) Pub. Date: Feb. 25, 2016

(54) Method for Generating Chapter Structures for Video Data Containing Images from a Surgical Microscope Object Area

(71) Applicants: Carl Zeiss Meditec AG, Jena (DE); Carl Zeiss AG, Oberkochen (DE)

(72) Inventors: Stefan Saur, Aalen (DE); Marco Wilzbach, Stuttgart (DE)

(21) Appl. No.: 14/831,321

(22) Filed: Aug. 20, 2015

(30) Foreign Application Priority Data
Aug. 20, 2014 (DE) 10 2014 216 511.3

(51) Int. Cl. G11B 27/10; G02B 21/36

(52) U.S. Cl. CPC G11B 27/10; G02B 21/365

(57) ABSTRACT

The invention relates to a method for generating a chapter structure constructed from individual chapters (no. 1, no. 2, no. 3, . . . ) for video data from a video data stream containing images captured in successive image frames from an object area of a surgical microscope, for which different operating states can be set. Here, an item of chapter information is determined for some of the successive image frames, and the successively captured image frames of the video data stream are classified in a chapter (no. 1, no. 2, no. 3, . . . ) of the chapter structure depending on the chapter information determined for some of the image frames. The chapter information is determined taking into account meta data containing an item of operating state information relating to the surgical microscope.

### CROSS REFERENCE TO RELATED APPLICATION

This application claims priority of German patent application no. 10 2014 216 511.3, filed Aug. 20, 2014, the entire content of which is incorporated herein by reference.

### FIELD OF THE INVENTION

The invention relates to a method for generating a chapter structure constructed from individual chapters for video data from a video data stream containing images captured in successive image frames from an object area of a surgical microscope, for which different operating states can be set, in which an item of chapter information is determined for at least some of the successive image frames, and in which the successively captured image frames of the video data stream are classified in a chapter of the chapter structure depending on the chapter information determined at least for some of the image frames.

### BACKGROUND OF THE INVENTION

Surgical microscopes are used in different medical disciplines, for example neurosurgery, minimally invasive surgery or else ophthalmology. They are used, in particular, to make it possible for a surgeon to view an operating area with magnification. An operating microscope is described in U.S. Pat. No. 4,786,155, for example.

In order to document surgical interventions and to create training material, the object area which can be visualized with magnification using an operating microscope is often recorded in surgical procedures using a video system which is integrated into the surgical microscope or is connected to the surgical microscope. This video system contains an image sensor which is used to capture images of the object area of the surgical microscope in successive image frames. However, the continuous capture of images of the object area over the entire duration of a surgical procedure results in very large quantities of video data. By virtue of the fact that a chapter structure is generated for the video data containing the successively captured image frames, it can be ensured that particular relevant images and image sequences can be quickly found from this data material and can be displayed. The chapter structure combines groups of successive image frames to form chapters in which the images in the image frames have a content corresponding to a particular time section of a surgical procedure.

In the present case, the generation of a chapter structure for video data from a video data stream is understood as meaning the classification of the images in the image frames in the video data stream in chapters containing a group of successive image frames.

A chapter structure for video data from a video data stream is often generated by virtue of the video data being manually sorted and processed by an operator using a computer program on a computer unit. However, this manual processing may be very time-consuming because of the often long duration of surgical procedures and the associated large quantity of video data.

A chapter structure for video data from recordings of operations is therefore also generated in a widespread manner by a surgeon manually initiating and stopping the recording of the operating microscope object area during the surgery using an image sensor. Although this may generally mean that only the important video data are stored, this method affects the surgeon's workflows. This method also does not ensure that, in particular when unforeseen events and complications arise, at least that section of the surgery with these events and complications is recorded. Experience shows that surgeons regularly start the recording of corresponding video data too late in this case.

So-called time-shift recorders are therefore also used to record surgical procedures, in the case of which recorders all video data from a continuous video data stream which are acquired in a particular continuous interval of time are respectively stored in a buffer memory which is connected to a main data memory. The surgeon can then use a control command on an operating unit to cause the video data from a particular interval of time to be transferred to the main data memory. However, such time-shift recorders do not make it possible to subsequently check particular sections of a surgical procedures in which the surgeon did not trigger the corresponding control command.

In order to ensure that image material is recorded and stored over the entire duration of a surgical procedure, it is also known practice to record individual images of the operating microscope object area at regular, fixed intervals of time using the video system in an operating microscope and to store these individual images. Although this results in the quantity of data being reduced for the image material recorded during a surgical procedure, the image material documents the surgical procedure only incompletely.

### SUMMARY OF THE INVENTION

An object of the invention is to provide a method for automatically generating a chapter structure for video data from a video data stream containing images captured in successive image frames from an object area of a surgical microscope, for which different operating states can be set, and to provide a computer program and a surgical microscope which can be used to carry out this method.

This object is achieved, on the one hand, by a method wherein the chapter information is determined taking into account meta data containing an item of operating state information relating to the surgical microscope, and, on the other hand, by a computer program and a surgical microscope having a computer unit which can be used to carry out this method.

The operating state information relating to the surgical microscope may contain, in particular, one or more items of information from the group cited below: information relating to a magnification of the surgical microscope, information relating to a focus setting of the surgical microscope, information relating to a zoom setting of the surgical microscope, information relating to the position of the focus point of the surgical microscope in an operating area, information relating to a setting of a lighting system of the surgical microscope; information relating to a setting of the surgical microscope for observing the object area under fluorescent light; information relating to a switching state of stand brakes of the surgical microscope; information relating to the execution of software applications on a computer unit of the surgical microscope; information relating to the actuation of operating elements of the surgical microscope.

The meta data taken into account when determining the chapter information may explicitly or else implicitly contain an item of operating state information relating to the surgical microscope in the meta data. In the present case, meta data which explicitly contain operating state information are understood as meaning those data which directly describe an operating state of the surgical microscope, for example a setting of stand brakes, a setting of a zoom system or a setting of a lighting system. In the present case, meta data which implicitly contain operating state information are understood as meaning those data which are directly or indirectly dependent on an operating state of the surgical microscope, for instance the setting of a lighting system or the setting of a zoom system, for example the brightness and/or the magnification of an image in an image frame.

The individual chapters of the automatically created chapter structure contain the images in the image frames for a particular operating scene according to the invention. In the sense of the invention, the term “chapter” also extends to so-called subchapters relating to a section of an operating scene. The chapter structure can therefore also be a tree structure, in particular. One concept of the invention is also to provide the chapters with a content summary in the form of a text label which correctly designates the relevant operating scene. This textual designation of a chapter can fundamentally also be carried out manually by an operator within the scope of the invention. Alternatively or additionally, it is also possible for an image representative of the chapter to be automatically allocated to each chapter or at least some of the chapters for the purpose of representation in a content summary. In this case, this image is linked to the corresponding chapter as clearly as possible, that is, the video data block, for example an item of identification information (ID) relating to the video and the starting and end time for the video.

The meta data containing an item of operating state information relating to the surgical microscope may also contain additional information relating to at least one feature of at least some of the images captured in the successive image frames in the video data stream. This additional information relating to at least one feature may also comprise an item of information relating to the recording time of an image in an image frame. This additional information relating to at least one feature may be, in particular, an item of information calculated using image processing. The additional information relating to at least one feature of at least some of the images captured in the successive image frames in the video data stream may contain, for example, an item of information relating to a characteristic pattern and/or a characteristic structure and/or a characteristic brightness and/or a characteristic color of an image in an image frame. In particular, the additional information relating to at least one feature of at least some of the images captured in the successive image frames in the video data stream may also comprise an item of information obtained from a comparison of images in successively captured image frames.

The additional information relating to at least one feature of at least some of the images captured in the successive image frames in the video data stream is advantageously an item of information which is invariant with respect to rotation and/or scaling change and/or tilting and/or shearing of images in successive image frames.

One concept of the invention is also to structure the meta data in feature vectors. The meta data preferably form feature vectors assigned to the successively captured image frames.

The feature vectors may be assigned to the successively captured image frames via an item of time information, in particular. In addition, the feature vectors may also be assigned to the successively captured image frames by storing the image in an image frame with the feature vector of the image frame.

The invention also proposes the fact that the meta data may comprise probability values for an image in an image frame which are calculated using a probability model adapted to a predefined chapter structure, and the chapter information can be effected by comparing the probability value determined for the image in an image frame or the probability values determined for images in a group of image frames with a chapter-specific comparison criterion. In this case, the probability model may be a probability model adapted to the predefined chapter structure in a learning process.

One concept of the invention is also the fact that the chapter structure may have a table of contents with contents for the individual chapters, a first or middle or last image frame of the chapter being defined as a content of a chapter or, on the basis of the assessment of differences between the meta data of the image frames in the chapter, an image frame from the chapter being stipulated as the content of the chapter.

### BRIEF DESCRIPTION OF THE DRAWINGS

The invention will now be described with reference to the drawings wherein:

FIG. 1 is a schematic showing a surgical microscope having an image sensor and a computer unit;

FIG. 2 shows image frames containing images from a video data stream obtained from the image sensor by the computer unit;

FIG. 3 shows a feature vector of an image frame from the video data stream; and,

FIG. 4 shows a chapter structure generated in the computer unit for the video data stream.

### DESCRIPTION OF THE PREFERRED EMBODIMENTS OF THE INVENTION

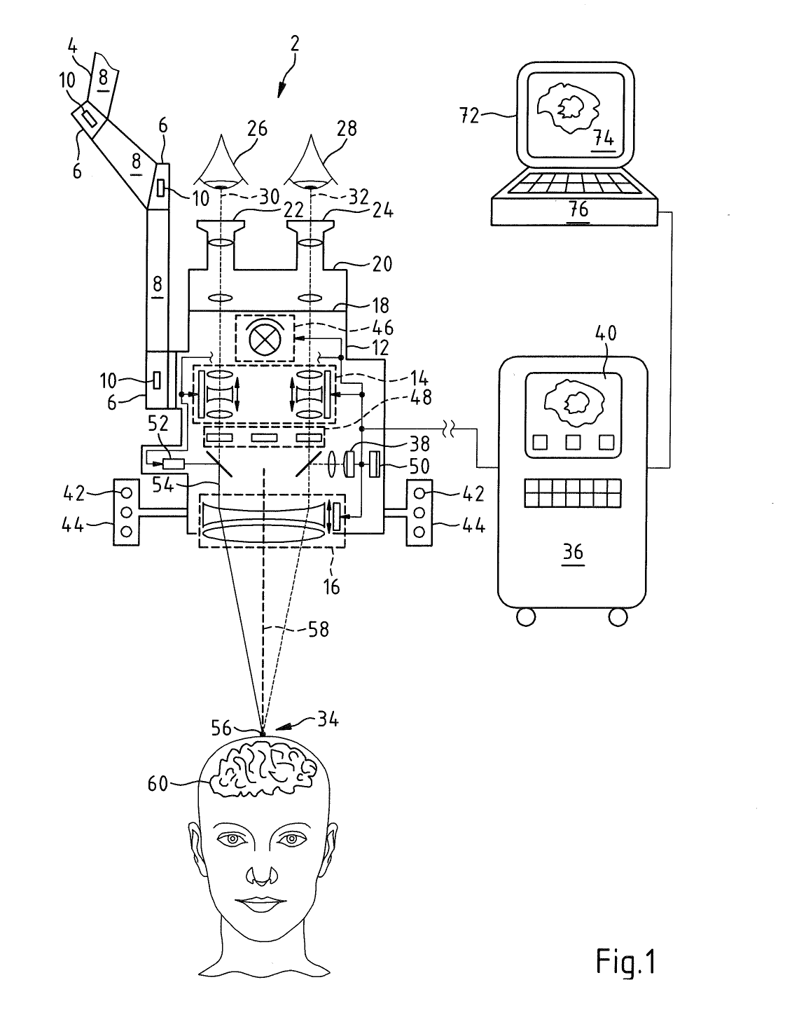

The stereoscopic surgical microscope 2 shown in FIG. 1 has a surgical microscope base body 12 which is fastened to a stand 4 having articulated arms 8 connected by swivel joints 6 and in which an adjustable magnification system 14 and a microscope main lens system 16 are accommodated. The swivel joints 6 of the articulated arms 8 can be released and blocked using stand brakes 10 arranged in the swivel joints 6.

The surgical microscope 2 has a binocular tube 20 which is connected to the base body 12 at an interface 18 and has a first and a second eyepiece (22, 24) for a left and a right eye (26, 28) of an observer. The microscope main lens system 16 in the surgical microscope 2 is permeated by a first observation beam path 30 and a second observation beam path 32 from an object area 34. The surgical microscope 2 contains a computer unit 36 which is connected to an image sensor 38 for capturing images of the object area 34. The adjustable magnification system 14 is a motor-adjustable zoom system which is connected to the computer unit 36 and can be adjusted there by an operator on a touch-sensitive screen 40 and using operator-controlled elements 42 on handles 44 which are secured to the surgical microscope base body 12. The microscope main lens system 16 can also be adjusted there.

The surgical microscope 2 has a lighting system 46 having a filter device 48 which makes it possible to examine the object area 34 with white light and with fluorescent light from a fluorescent dye applied in the object area 34. The lighting system 46 and the filter device 48 may also be configured using the touch-sensitive screen 40 of the computer unit 36 and the operator-controlled elements 42 on the handles 44.

The surgical microscope 2 contains an autofocus system 50 having a laser 52 which generates a laser beam 54 which is guided through the microscope main lens system 16. The laser beam 54 generates, in the object area 34, a laser spot 56, the offset of which from the optical axis 58 of the microscope main lens 16 can be determined using the image sensor 38. The stand brakes 10 of the swivel joints 6 can be selectively released and blocked using the operator-controlled elements 42 on the handles 44. When the stand brakes 10 are released, the surgical microscope base body 12 can be moved by an operator of the surgical microscope 2 substantially without force.

The surgical microscope 2 shown in FIG. 1 is configured to be used for a tumor resection in the brain of a patient 60. This surgical procedure is carried out in four successive operating phases which are indicated in the table below. If the object area 34 of the surgical microscope 2 is captured using the image sensor 38 during this surgical procedure, the images in the image frames of the video data of the video data stream supplied to the computer unit 36 have the content indicated in the table.

A meaningful chapter structure for a video data stream which is generated using the image sensor 38 during this surgical procedure therefore divides the video data stream into 4 chapters in which the images in the image frames from the surgery phases cited in the table below are classified with the reference labels no. 1, no. 2, no. 3 and no. 4.

TABLE

| Surgery phase | Properties | No. |
|---|---|---|
| Before opening | Scalp primarily visible, | 1 |
| the skull | possibly also hairs if the | |
| (craniotomy) | skull has not been shaved. | |
| | Zoom, focus, position | |
| | changes possibly present. | |
| After opening the | Cranial bone has been | 2 |
| skull, before | removed. The dura (outermost | |
| opening the dura | meninx) and veins (appear | |
| | bluish) on the dura are | |
| | visible. Possibly zoom and | |
| | focus, position changes. | |
| Tumor resection | Brain visible, blood | 3 |
| (white light | visible, red tones are | |
| mode) | dominant. Possibly zoom and | |
| | focus changes. | |
| Tumor resection | Brain visible, blood | 4 |
| (fluorescence | visible, blue tones are | |
| mode using 5-ALA | dominant. Possibly zoom and | |
| fluorescence) | focus changes. | |

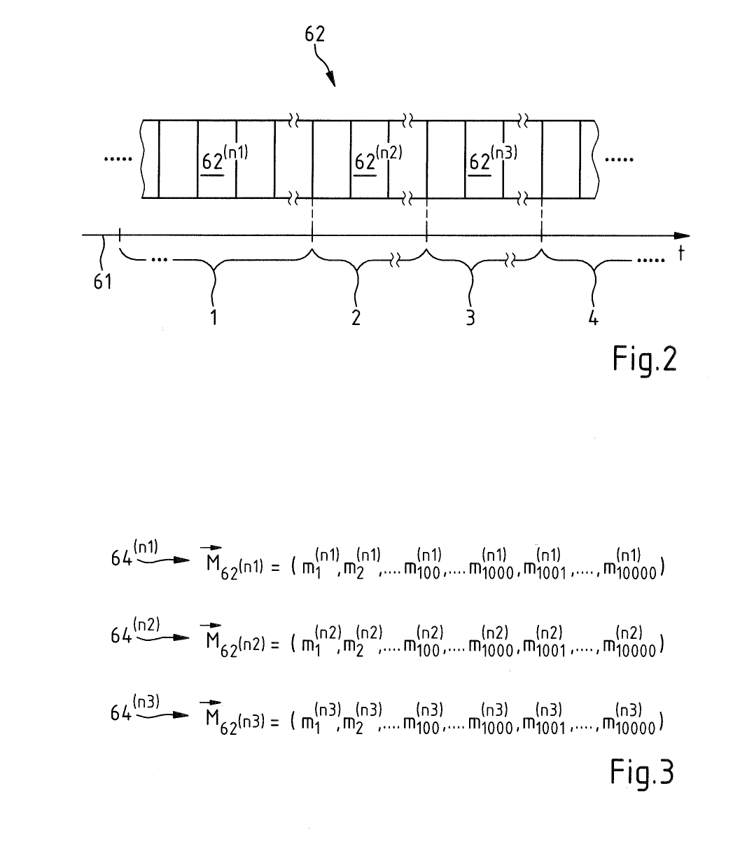

FIG. 2 shows the image frames (62⁽ⁿ¹⁾, 62⁽ⁿ²⁾, 62⁽ⁿ³⁾) containing images captured at a time (t) on the time axis 61 in the video data stream 62 supplied to the computer unit 36 during this surgical procedure.

The computer unit 36 first of all assigns a feature vector (64⁽ⁿ¹⁾, 64⁽ⁿ²⁾, 64⁽ⁿ³⁾) to each image frame (62⁽ⁿ²⁾, 62⁽ⁿ²⁾, 62⁽ⁿ³⁾). FIG. 3 shows such a feature vector (64⁽ⁿ³⁾, 64⁽ⁿ²⁾, 64⁽ⁿ³⁾) for the image frames (62⁽ⁿ³⁾, 62⁽ⁿ²⁾, 62⁽ⁿ³⁾). The feature vector (64⁽ⁿ¹⁾, 64⁽ⁿ²⁾, 64⁽ⁿ³⁾) for the image frames (62⁽ⁿ¹⁾, 62⁽ⁿ²⁾, 62⁽ⁿ³⁾) has 10,000 components. In the present case, these components comprise information relating to the operating state of the surgical microscope 2, for example the setting of the magnification system 14 and of the lighting system 46, information relating to colors in the image in an image frame (62⁽ⁿ¹⁾, 62⁽ⁿ²⁾, 62⁽ⁿ³⁾), information relating to brightness in the image in an image frame (62⁽ⁿ¹⁾, 62⁽ⁿ²⁾, 62⁽ⁿ³⁾), information calculated from the image in an image frame (62⁽ⁿ¹⁾, 62⁽ⁿ²⁾, 62⁽ⁿ³⁾) using image processing, for example information relating to whether typical spatial structures are present in the image in an image frame (62⁽ⁿ¹⁾, 62⁽ⁿ²⁾, 62⁽ⁿ³⁾).

It should be noted that, within the scope of the invention, a feature vector for the image frames may fundamentally have fewer than 10,000 components, for instance only 10 or 100 components, or else more than 10,000 components.

For a chapter structure predefined for the computer unit 36, using the feature vector (64⁽ⁿ¹⁾, 64⁽ⁿ²⁾, 64⁽ⁿ³⁾) of each image frame, the chapter structure then assigns the image in the image frame in the video data from the video data stream from the image sensor 38 to the chapter of the preceding image frame (62⁽ⁿ¹⁻¹⁾, 62⁽ⁿ²⁻¹⁾, 62⁽ⁿ³⁻¹⁾) or to a new chapter with a classifier K in the form of a probability value W(\vec{M}₆₂_{⁽ⁿ¹⁾},\vec{M}₆₂_{^{(n1−1)}}) calculated using a probability function and assessed using a probability criterion K_{W}. If the probability criterion K_{W} is satisfied, the relevant image frame (62⁽ⁿ¹⁾, 62⁽ⁿ²⁾, 62⁽ⁿ³⁾) is classified in the same chapter as the preceding image. In contrast, if the probability criterion K_{W} is not satisfied, the relevant image frame (62⁽ⁿ¹⁾, 62⁽ⁿ²⁾, 62⁽ⁿ³⁾) is classified in a chapter following that chapter in which the preceding image frame has been classified.

It should be noted that a probability function W suitable for a particular surgical procedure can be determined in a learning process, in particular as follows:

The videos which are captured in clinical practice using a surgical microscope 2 explained above and have video data streams relating to (n) tumor resections with the operating phases indicated in the table above on a computer unit are evaluated by extracting (m) image frames from these video data streams for each chapter no. 1, no. 2, no. 3 and no. 4. Feature vectors 64⁽ⁱ⁾ containing static and dynamic features are then determined for each image frame (i) and each image frame (i) is provided with a reference label by an operator.

The feature vectors calculated for each image frame and the associated reference labels are then used as a training set for training a classifier. This classifier is then used to calculate a probability value W(\hat{M}₆₂_{⁽ⁱ⁾}, \hat{M}₆₂_{⁽ⁱ⁾}) of two selected image frames belonging to the same chapter from the feature vectors (64⁽ⁱ⁾, 64^{(j)}) of the image frames using a probability function W, as described, for example, in the Internet reference “http://en.wikipedia.org/wiki/Statisticalclassification”. During the learning process, the features needed for robust differentiation are then selected or are accordingly provided with a high weighting. This operation thus results in a parameterized classifier K which, for two given feature vectors, indicates a probability value of the images in the two associated image frames (62⁽ⁱ⁾, 62⁽ⁱ⁾) belonging to the same chapter.

On the basis of fundamentally known classification approaches, for example Adaboost, Random Forests, SVM, Decision Trees etc., a model or a combination of models for automatically comparing image frames or a collection of image frames is therefore learnt. The aim of such a model is always to calculate a probability W(\hat{M}₆₂_{⁽ⁱ⁾},\hat{M}₆₂_{⁽ⁱ⁾}) of the two image frames or a collection of image frames belonging to the same chapter or to a different chapter. If this probability is below a limit value previously stipulated as a probability criterion K_{W}, the two image frames (62⁽ⁱ⁾, 62^{(j)}) are assigned to different chapters.

It is noted that a chapter structure can also be determined for video data from a video data stream using a so-called “unsupervised” classification approach, for example using the so-called algorithm from upicto, using so-called “hidden Markov models” and using hierarchical Dirichlet processes. For this purpose, the video data from a video data stream are first of all broken down into image frames, as described above, and features of the relevant image in the image frame which are characteristic of each image frame are then calculated.

In addition to the features extracted from the image frames, information relating to the operating state of the surgical microscope 2 may also be taken into account in this case as meta data, for example the setting of the magnification system 14 and the setting of the microscope main lens system 16, the focusing state of the surgical microscope 2, the setting of the lighting system 46, the setting of the stand brakes 10 et cetera. The features of the image frames are then compared using statistical mathematical methods. In this case, the analysis is not limited to individual image frames, with the result that a plurality of image frames can also be combined and can be compared with another combination of image frames. If the comparison reveals that the difference between two image frames is above a previously stipulated limit value, the image frames are assigned to two different chapters.

There are a plurality of strategies for selecting an image representing a chapter in a table of contents:
The temporally first/middle/last image frame in the chapter is selected;
a middle image frame is selected on the basis of a difference between features of the image frames inside the chapter.

A statistical model must always be learnt on the basis of training data in a learning process, that is, there must be pairs of image frames with the corresponding information relating to whether or not they belong to the same chapter. In this case, the set of training data should cover an expected range in an envisaged application. The advantage of this solution is that the meta information relating to the surgical microscope can be better integrated in the model by means of learning examples. By way of example, the model can be learnt to the effect that no new chapters can be created, for example, during changes to the magnification of the surgical microscope 2.

In order to reduce the amount of training, that is, the creation of classified data, approaches from the so-called “active” or “semi-supervised learning” can also be used, that is, data for the training are classified using models which have already been learnt.

It should also be noted that hybrid approaches can also be pursued for the above-described classification of image frames, in which hybrid approaches non-classified image frames are compared with classified image frames by calculating a comparison value. If, for example, the comparison value is in a particular range, the user is asked whether or not both image frames belong to the same chapter.

It should also be noted that it is fundamentally also possible to train a classifier using a few classified image frames. For this purpose, a model is applied to non-classified data in order to generate additional labels for a training step. If there is uncertainty in the distinction, that is, if the probability value W determined for an image frame is within a particular range of values, a user is asked whether or not both image frames should be classified in the same chapter. This method can be applied to all available classified data or else non-classified data can be automatically selected in a targeted manner to the effect that the data are a meaningful addition to the previous model.

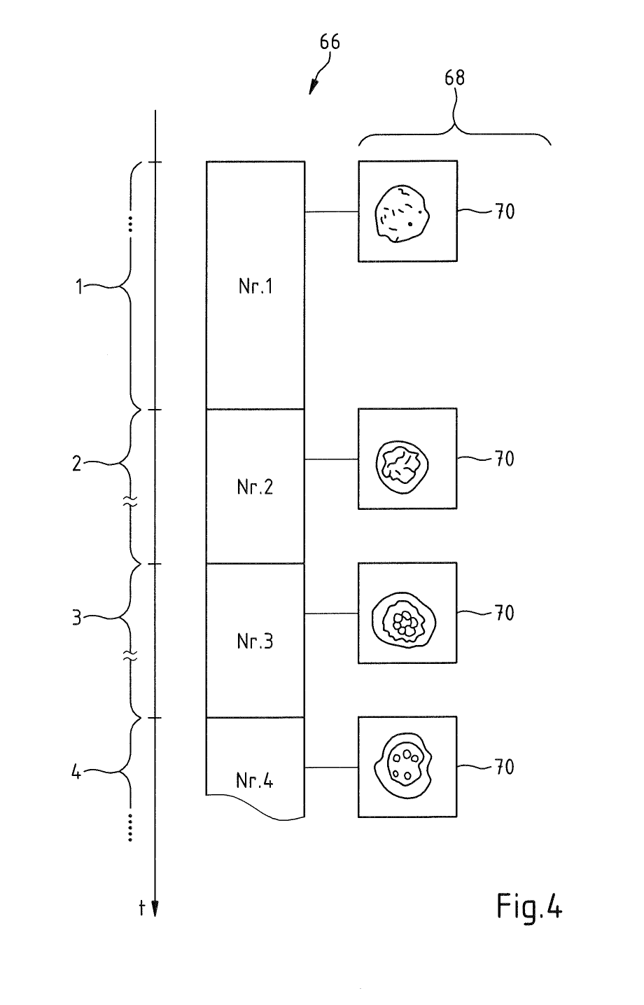

FIG. 4 shows a chapter structure 66 which is created in the computer unit 36 of the operating microscope 2 for the video data from the video data stream 62. The chapter structure 66 has the chapters no. 1, no. 2, no. 3 and no. 4 and contains a table of contents 68 with the contents 70.

The invention makes it possible to easily navigate in the images in the image frames of a video data stream. This is because an operator can also call up a video containing a video data stream on a display unit 74 of a further computer unit 72 which is connected to the computer unit 36 of the operating microscope 2 and is situated, for example, in an office outside the operating theater by virtue of the operator marking the desired video, by way of example, for instance using the FORUM Viewer computer program from Carl Zeiss Meditec AG. The table of contents for the video is then loaded from a data storage unit onto the display unit 74 of the computer unit 72 if not already present in the buffer of the display unit 74. The operator can now navigate through the table of contents and gains a quick overview of the video with the representative content images.

If an operator has a detailed interest in a chapter or else a plurality of chapters no. 1, no. 2, no. 3, no. 4, the operator can mark the corresponding chapters on the basis of their indicated content 70. The video data in the corresponding chapters are then loaded from the data storage unit 76 of the computer unit 72 and are displayed on the display unit 74. This means that the entire video need not be transmitted in order to display individual chapters no. 1, no. 2, no. 3, no. 4 of the video data of the video data stream 62, which enables efficient navigation.

It should also be noted that the table of contents 68 and video data need not necessarily be stored in the same data storage unit. The video can be stored, for example, in a FORUM data storage unit from Carl Zeiss Meditec AG and the table of contents can then be stored on the surgical microscope. If clear linking is ensured, there may even be a plurality of copies of the table of contents 68 and also of the video data. It is then possible to already load tables of contents 68 onto display units 40, 74 in advance, thus ensuring rapid access.

It should also be noted that a chapter structure 66 can be created for a video data stream 62 both off-line, that is, after a recording has taken place, and online, that is, directly during a recording. In order to calculate the chapters for the image frames in the video data stream 62, one of the solutions described above is started in an internal data processing unit. For the off-line variant, the data processing unit first of all loads the video and the meta information stored with the video. For the online variant, the data processing unit connects to the internal bus of the surgical microscope in order to gain access to the meta information and image information. The method described above is then used to create the table of contents. The table of contents is then transmitted, together with video data, to the data storage unit(s) provided.

Finally, it should be noted that a table of contents 68 can also be created on an external data processing unit, for example a Forum data processing unit from Carl Zeiss Meditec AG, a PACS data processing unit or a cloud data processing unit. For this purpose, differing from that described above, the video data and the associated meta data containing the operating state information relating to the surgical microscope must be transmitted from the surgical microscope to the data processing unit, for example using a data memory in the form of a USB stick and possibly a network or directly as a live stream via a network. The table of contents is then automatically calculated on the external data processing unit.

It is expressly pointed out that the invention cannot only be implemented with a surgical microscope configured for neurosurgical use, but can also be implemented, in particular, with an operating microscope for ophthalmology, an ENT operating microscope or an operating microscope which is suitable for use in other medical disciplines.

In summary, the following can be stated, in particular: the invention relates to a method for generating a chapter structure 66 constructed from individual chapters for video data from a video data stream 62 containing images captured in successive image frames 62⁽ⁿ¹⁾ from an object area 34 of a surgical microscope 2, for which different operating states can be set. In this case, an item of chapter information is determined for at least some of the successive image frames 62⁽ⁿ¹⁾ and the successively captured image frames 62⁽ⁿ¹⁾ of the video data stream are classified in a chapter of the chapter structure 66 depending on the chapter information determined at least for some of the image frames 62⁽ⁿ¹⁾. The chapter information is determined taking into account meta data containing an item of operating state information relating to the surgical microscope.

It is understood that the foregoing description is that of the preferred embodiments of the invention and that various changes and modifications may be made thereto without departing from the spirit and scope of the invention as defined in the appended claims.

### LIST OF REFERENCE SYMBOLS

2 Surgical microscope
4 Stand
6 Swivel joint
8 Articulated arm
10 Stand brake
12 Surgical microscope base body
14 Magnification system
16 Microscope main lens system
18 Interface
20 Binocular tube
22, 24 Eyepiece
26, 28 Eye
30, 32 Observation beam path
34 Object area
36 Computer unit
38 Image sensor
40 Display unit, screen
42 Operator-controlled element
44 Handle
46 Lighting system
48 Filter device
50 Autofocus system
52 Laser
54 Laser beam
56 Laser spot
58 Axis
60 Patient
61 Time axis
62⁽ⁱ⁾ Image frame
62 Video data stream
64⁽ⁱ⁾ Feature vector
66 Chapter structure
68 Table of contents
70 Content
72 Computer unit
74 Display unit
76 Data storage unit

1. A method for generating a chapter structure constructed from individual chapters (no. 1, no. 2, no. 3, . . . ) for video data from a video data stream containing images captured in successive image frames (62⁽ⁱ⁾, 62⁽ⁱ⁺¹⁾ . . . ) from an object area of a surgical microscope for which different operating states can be set, the method comprising the steps of:
determining an item of chapter information for a portion of the successive image frames (62⁽ⁱ⁾, 62⁽ⁱ⁺¹⁾ . . . );
classifying the successive image frames (62⁽ⁱ⁾, 62⁽ⁱ⁺¹⁾ . . . ) of the video data stream in a chapter (no. 1, no. 2, no. 3, . . . ) of the chapter structure in dependence upon the chapter information determined for the portion of the successive image frames (62⁽ⁱ⁾, 62⁽ⁱ⁺¹⁾ . . . ); and,
carrying out the determination of the chapter information taking into account meta data containing an item of operating state information of the surgical microscope.

2. The method of claim 1, wherein the operating state information relating to the surgical microscope contains one or more items of information from the group: information as to a magnification of the surgical microscope; information as to a focus setting of the surgical microscope; information as to a zoom setting of the surgical microscope; information as to a position of a focus point of the surgical microscope in the object area; information as to a setting of an illuminating system of the surgical microscope; information as to a setting of the surgical microscope for observing the object area under fluorescent light; information as to a switching state of stand brakes of the surgical microscope; information as to the execution of software applications on a computer unit of the surgical microscope; and, information as to the actuation of operator-controlled elements of the surgical microscope.

3. The method of claim 1, wherein feature vectors (64⁽ⁱ⁾) are assigned to the successively captured image frames (62⁽ⁱ⁾) by storing the image in an image frame (62⁽ⁱ⁾) with the feature vector of the image frame (62⁽ⁱ⁾).

4. The method of claim 1, wherein the meta data include probability values W(\hat{M}₆₂_{⁽ⁱ⁾},\hat{M}₆₂_{⁽ⁱ⁾}) for an image in an image frame (62⁽ⁱ⁾) which are calculated using a probability model adapted to a predefined chapter structure, and the chapter information is effected by comparing the probability value W(\hat{M}₆₂_{⁽ⁱ⁾},\hat{M}₆₂_{^{(j)}}) determined for the image in an image frame or the probability values W(\hat{M}₆₂_{⁽ⁱ⁾},\hat{M}₆₂_{^{(j)}},\hat{M}₆₂_{^{(k)}},\hat{M}₆₂_{^{(l)}} . . . ) determined for images in a group of image frames (62⁽ⁱ⁾, 62^{(j)}, 62^{(k)}, 62^{(l)}) with a chapter-specific comparison criterion K_{W}.

5. The method of claim 1, wherein the meta data contain additional information as to at least one feature of at least some of the images captured in the successive image frames (62⁽ⁱ⁾, 62⁽ⁱ⁺¹⁾) in the video data stream.

6. The method of claim 5, wherein the additional information relating to at least one feature includes an item of information as to the recording time point of an image in an image frame (62⁽ⁱ⁾).

7. The method of claim 5, wherein the additional information relating to at least one feature of at least some of the images captured in the successive image frames (62⁽ⁱ⁾) in the video data stream includes an item of information calculated from the image in an image frame (62⁽ⁿ¹⁾, 62⁽ⁿ²⁾, 62⁽ⁿ³⁾) using image processing.

8. The method of claim 7, wherein said item of information includes at least one of the following: item of information as to a characteristic pattern, a characteristic structure, a characteristic brightness and a characteristic color of an image in an image frame (62⁽ⁱ⁾).

9. The method of claim 5, wherein the additional information relating to at least one feature of at least some of the images captured in the successive image frames (62⁽ⁱ⁾) in the video data stream includes an item of information obtained from a comparison of images in successively captured image frames (62⁽ⁱ⁾).

10. The method of claim 5, wherein the additional information relating to at least one feature of at least some of the images captured in the successive image frames (62⁽ⁱ⁾) in the video data stream is an item of information which is invariant with respect to at least one of: rotation, scaling change, tilting and shearing of images in successive image frames.

11. The method of claim 1, wherein the meta data form feature vectors (64⁽ⁱ⁾) assigned to the successively captured image frames (62⁽ⁱ⁾).

12. The method of claim 11, wherein the feature vectors (64⁽ⁱ⁾) are assigned to the successively captured image frames (62⁽ⁱ⁾) via an item of time information.

13. The method of claim 4, wherein the probability model is a probability model adapted to the predefined chapter structure in a learning process.

14. The method of claim 1, wherein the chapter structure has a table of contents with contents for the individual chapters, a first or middle or last image frame (62⁽ⁱ⁾) of the chapter being defined as a content of a chapter or, on the basis of the assessment of differences between the meta data of the image frames (62⁽ⁱ⁾) in the chapter, an image frame (62⁽ⁱ⁾) from the chapter being stipulated as the content of the chapter.

15. A computer program for classifying images contained in successively captured image frames (62⁽ⁱ⁾) in a video data stream relating to an object area of a surgical microscope, for which different operating states can be set, in a predefined chapter structure for the video data stream, using a computer unit in accordance with a method comprising the steps of:
determining an item of chapter information for a portion of the successive image frames (62⁽ⁱ⁾, 62⁽ⁱ⁺¹⁾ . . . );
classifying the successive image frames (62⁽ⁱ⁾, 62⁽ⁱ⁺¹⁾ . . . ) of the video data stream in a chapter (no. 1, no. 2, no. 3, . . . ) of the chapter structure in dependence upon the chapter information determined for the portion of the successive image frames (62⁽ⁱ⁾, 62⁽ⁱ⁺¹⁾ . . . ); and,
carrying out the determination of the chapter information taking into account meta data containing an item of operating state information of the surgical microscope.

16. A surgical microscope comprising:
a computer unit containing a computer program for classifying images contained in successively captured image frames (62⁽ⁱ⁾) in a video data stream relating to an object area of a surgical microscope, for which different operating states can be set, in a predefined chapter structure for the video data stream, using a computer unit in accordance with a method including the steps of:
determining an item of chapter information for a portion of the successive image frames (62⁽ⁱ⁾, 62⁽ⁱ⁺¹⁾ . . . ) ;
classifying the successive image frames (62⁽ⁱ⁾, 62⁽ⁱ⁺¹⁾ . . . ) of the video data stream in a chapter (no. 1, no. 2, no. 3, . . . ) of the chapter structure in dependence upon the chapter information determined for the portion of the successive image frames (62⁽ⁱ⁾, 62⁽ⁱ⁺¹⁾ . . . ); and,
carrying out the determination of the chapter information taking into account meta data containing an item of operating state information of the surgical microscope.
